(19) United States
(12) Patent Application Publication
(10) Pub. No.: US 2004/0181651 A1
(43) Pub. Date: Sep. 16, 2004

(54) Issue bandwidth in a multi-issue out-of-order processor

(76) Inventors: Rabin A. Sugumar, Sunnyvale, CA (US); Chandra M.R. Thimmannagari, Fremont, CA (US); Sorin Lacobovici, San Jose, CA (US); Robert Nuckolls, Santa Clara, CA (US)

Correspondence Address: OSHA & MAY L.L.P./SUN, 1221 MCKINNEY, SUITE 2800, HOUSTON, TX, 77010, US

(21) Appl. No.: 10/386,349

(22) Filed: Mar. 11, 2003

(51) Int. Cl. G06F 9/30

(52) U.S. Cl. 712/214

(57) ABSTRACT

A multi-issue microprocessor selectively assigns, with particular emphasis on an particular type of instruction, in a plurality of instructions to various pipelines. The microprocessor maintains counts of the number of instructions assigned to a first pipeline and a second pipeline. Depending on these counts, the processor assigns instructions of the particular type in the plurality of instructions to the first and second pipelines.

### BACKGROUND OF INVENTION

A typical computer system includes at least a microprocessor and some form of memory. The microprocessor has, among other components, arithmetic, logic, and control circuitry that interpret and execute instructions necessary for the operation and use of the computer system. FIG. 1 shows a typical computer system 10 having a microprocessor 12, memory 14, integrated circuits (IC) 16 that have various functionalities, and communication paths 18 and 20, i.e., buses and wires, that are necessary for the transfer of data among the aforementioned components of the computer system 10.

Improvements in microprocessor (e.g., 12 in FIG. 1) performance continue to surpass the performance gains of their memory sub-systems. Higher clock rates and increasing number of instructions issued and executed in parallel account for much of this improvement. By exploiting instruction level parallelism, microprocessors are capable of issuing multiple instructions per clock cycle. In other words, such a “multi-issue” microprocessor is capable of dispatching, or issuing, multiple instructions each clock cycle to one or more pipelines in the microprocessor.

### SUMMARY OF INVENTION

According to one aspect of one or more embodiments of the present invention, a method for handling a plurality of instructions in a multi-issue processor comprises: determining whether there is a particular type of instruction in the plurality of instructions, and if there is the particular type of instruction: determining a first number of instructions assigned to a first pipeline; determining a second number of instructions assigned to a second pipeline; comparing the first number and the second number; and assigning instructions of the particular type in the plurality of instructions to one of the first pipeline and the second pipeline depending on the comparing.

According to another aspect of one or more embodiments of the present invention, a method for handling a plurality of instructions in a multi-pipelined processor comprises step for determining whether there is a particular type of instruction in the plurality of instructions, and if there is the particular type of instruction: step for determining a first number of instructions assigned to a first pipeline; step for determining a second number of instructions assigned to a second pipeline; step for comparing the first number and the second number; and step for assigning instructions of the particular type in the plurality of instructions to one of the first pipeline and the second pipeline depending on the step for comparing.

According to another aspect of one or more embodiments of the present invention, a microprocessor having a first pipeline and a second pipeline comprises an instruction fetch unit arranged to fetch a plurality of instructions and an instruction decode unit arranged to assign identification information to the plurality of instructions, where the instruction decode unit is arranged to maintain a first count and a second count, and where the instruction decode unit is arranged to assign instructions of a particular type in the plurality of instructions to one of the first pipeline and the second pipeline dependent on the first count and the second count.

According to another aspect of one or more embodiments of the present invention, a method for handling a plurality of instructions in a processor having at least a first pipeline and a second pipeline comprises determining if there is an arithmetic logic instruction in the plurality of instructions, and if there is an arithmetic logic instruction in the plurality of instructions: querying a first counter indicative of an amount of instructions assigned to the first pipeline; querying a second counter indicative of an amount of instructions assigned to the second pipeline; if a value of the first counter is greater than a value of the second counter, assigning arithmetic logic instructions in the plurality of instructions to the second pipeline; and if the value of the first counter is less than the value of the second counter, assigning arithmetic logic instructions in the plurality of instructions to the first pipeline.

Other aspects and advantages of the invention will be apparent from the following description and the appended claims.

### BRIEF DESCRIPTION OF DRAWINGS

FIG. 1 shows a typical computer system.

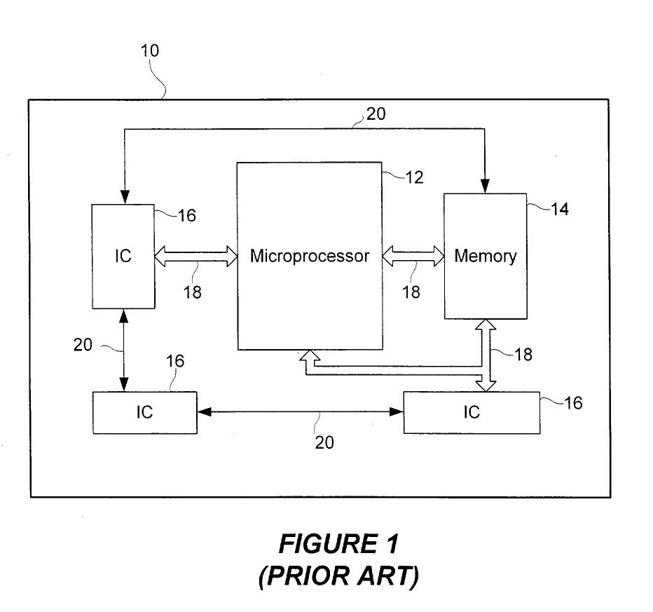

FIG. 2 shows a block diagram of an instruction flow in a multi-issue microprocessor.

FIG. 3 shows a flow process in accordance with an embodiment of the present invention.

FIG. 4 shows a pipeline diagram in accordance with an embodiment of the present invention.

### DETAILED DESCRIPTION

Embodiments of the present invention relate to a method for issuing instructions in a multi-issue microprocessor so as to improve instruction issue bandwidth.

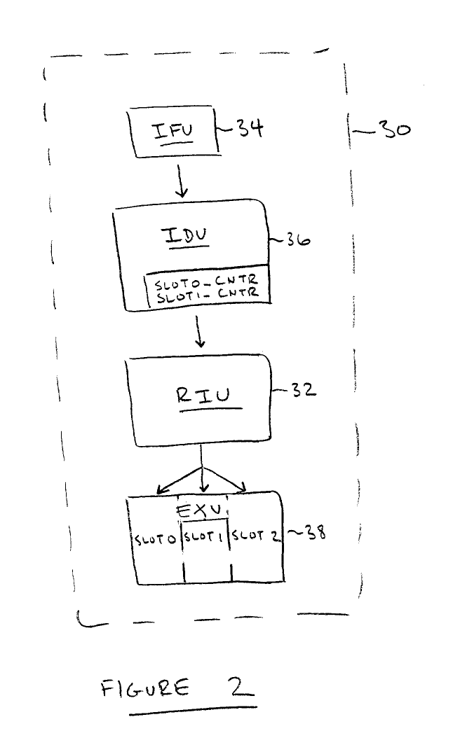

Referring to FIG. 2, a portion of an exemplary multi-issue microprocessor 30 in accordance with an embodiment of the present invention is shown. The microprocessor 30 includes an instruction fetch unit (IFU) 34, an instruction decode unit (IDU) 36, a rename and issue unit (RIU) 32, and an execution unit (EXU) 38.

The instruction fetch unit 34 is arranged to provide a group, or bundle, of 0-n instructions, forming an instruction fetch bundle (or instruction fetch group), in a given clock cycle. For example, in a 3-way superscalar multi-issue microprocessor, the instruction fetch unit 34 fetches 3 instructions in a given clock cycle. The instruction decode unit 36 decodes the instructions in the instruction fetch bundle and provides the decoded information to the rename and issue unit 32. The rename and issue unit 32 is arranged to rename source registers and update rename tables with the latest renamed values of destination registers provided by the instruction decode unit 36. Moreover, the rename and issue unit 32 is also arranged to force dependencies and pick and issue instructions in an out-of-order sequence to the execution unit 38. The execution unit 38 includes three pipelines, or “slots” (SLOT 0, SLOT 1, and SLOT 2), that are responsible for executing instructions issued from the rename and issue unit 32.

Continuing with the example of a 3-way superscalar multi-issue microprocessor 30 in accordance with one embodiment of the present invention, the rename and issue unit 32 can distribute, or issue, the three instructions to any one of the three pipelines in the execution unit 38. As arithmetic logic instructions (instructions dependent on an arithmetic logic unit (ALU), e.g., ADD, SUB, AND, OR, etc.) typically make up 50% of the instructions collectively fetched by the instruction fetch unit 34 over some period of time, the placement of such arithmetic logic instructions in different slots is important.

In the embodiment of the present invention shown in FIG. 2, the first slot, or first pipeline, SLOT 0, may be assigned one of the following types of instructions: integer ALU instructions and load/store instruction. The second slot, or second pipeline, SLOT 1, may be assigned one of the following types of instructions: integer ALU instructions, integer conditional move instructions, integer multiply/divide instructions, branch-on-register instructions, and a few types of floating point and graphics instructions. The third slot, or third pipeline, SLOT 2, may be assigned most of the types of floating point and graphics instructions and branch-on-condition instructions.

Accordingly, arithmetic logic instructions may be issued to either SLOT 0 or SLOT 1. If such arithmetic logic instructions are assigned to pipelines randomly, there is a potential for performance loss in that cycle time use may be inefficient. For example, if SLOT 0 is consecutively issued five arithmetic logic instructions and SLOT 1 is not issued any arithmetic logic instructions, then the execution of the five arithmetic logic instructions will take at least five clock cycles versus a lesser number of clock cycles that would be required were the fourth and fifth arithmetic logic instructions issued to SLOT 1.

In the present invention, instead of randomly assigning and issuing instructions, the instruction decode unit 36 in the micro-processor 30 assigns, or allots, slot identification tags to instructions that get fetched in a given instruction fetch bundle (by the instruction fetch unit 34). An issue queue then distributes instructions to the appropriate slots depending on the identification information of the instructions.

The instruction decode unit 36 maintains 2, 5-bit counters (for an exemplary 32-entry issue queue), SLOT0_CNTR[4:0] and SLOT1_CNTR[4:0]. SLOT0_CNTR is incremented when the instruction decode unit 36 detects that there are instructions in the current instruction fetch bundle that need to be steered to SLOT 0. In other words, the instruction decode unit 36 increments SLOT0_CNTR when the instruction decode unit 36 assigns (as described below) instructions in the current instruction fetch bundle to SLOT 0. The amount by which SLOT0_CNTR gets incremented depends on the number of instructions in the current instruction fetch bundle that the instruction decode unit 36 assigns to SLOT 0. For example, if two of the three instructions in the current instruction fetch bundle are assigned by the instruction decode unit 36 to SLOT 0, SLOT0_CNTR is incremented by two. This counter, SLOT0_CNTR, gets decremented as the issue queue issues valid instructions to SLOT 0.

SLOT1_CNTR is incremented when the instruction decode unit 36 detects that there are instructions in the current instruction fetch bundle that need to be steered to SLOT 1. In other words, the instruction decode unit 36 increments SLOT1_CNTR when the instruction decode unit 36 assigns (as described below) instructions in the current instruction fetch bundle to SLOT 1. The amount by which SLOT1_CNTR gets incremented depends on the number of instructions in the current instruction fetch bundle that the instruction decode unit 36 assigns to SLOT 1. For example, if three instructions in the current instruction fetch bundle are assigned by the instruction decode unit 36 to SLOT 1, SLOT1_CNTR is incremented by three. This counter, SLOT1_CNTR, gets decremented as the issue queue issues valid instructions to SLOT 1.

In assigning arithmetic logic instructions, when the instruction decode unit 36 comes across arithmetic logic instructions that could be either steered to SLOT 0 or SLOT 1, the instruction decode unit 36 does one of the following: assigns all the arithmetic logic instructions in the current instruction fetch bundle to SLOT 1 if the value of SLOT0_CNTR is greater than the value of SLOT1_CNTR; assigns all the arithmetic logic instructions in the current instruction fetch bundle to SLOT 0 if the value of SLOT0_CNTR is less than the value of SLOT1_CNTR; or assigns all the arithmetic logic instructions in the current instruction fetch bundle to SLOT 1 if the value of SLOT0_CNTR is equal to the value of SLOT1_CNTR. Alternatively, those skilled in the art will understand that, in one or more other embodiments of the present invention, the instruction decode unit 36 may assign all the arithmetic logic instructions in the current fetch instruction bundle to SLOT 0 if the value of SLOT0_CNTR is equal to the value of SLOT1_CNTR.

Those skilled in the art will understand that, in one or more embodiments, the allotment of particular types of instructions to different slots may vary according to system parameters and desires. Moreover, those skilled in the art will understand that, in one or more embodiments of the present invention, a number less than all of the arithmetic logic instructions in a particular instruction fetch bundle may be assigned to a particular pipeline.

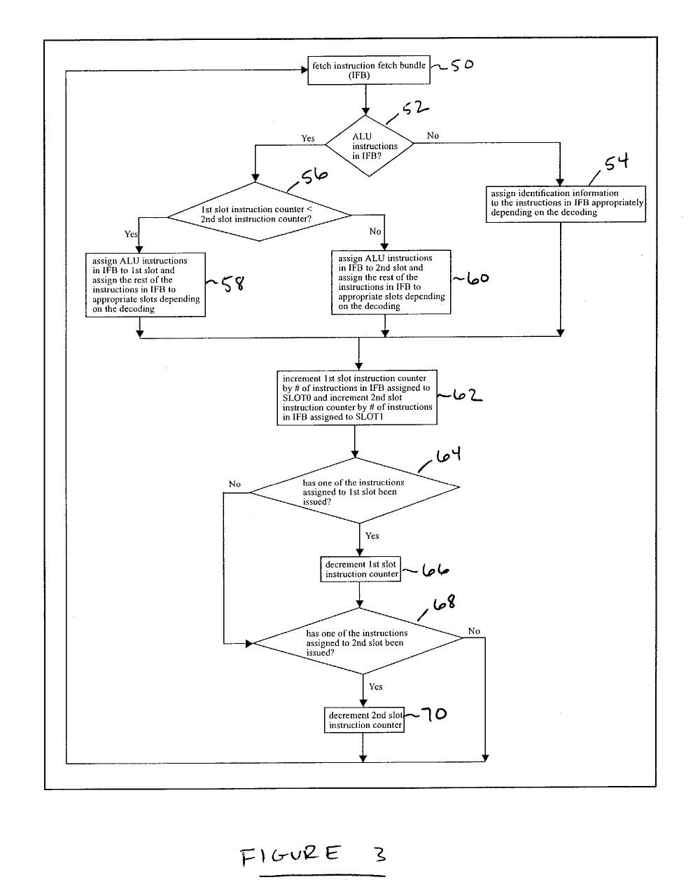

FIG. 3 shows an exemplary flow process in accordance with an embodiment of the present invention. In FIG. 3, an instruction fetch bundle is fetched 50. Thereafter, a determination is made as to whether there are any arithmetic logic instructions in the instruction fetch bundle 52. If there are no arithmetic logic instructions in the instruction fetch bundle 52, each instruction in the instruction fetch bundle is assigned identification information dependent on the decoding of the instructions 54. In this case, the instructions in the instruction fetch bundle are assigned destination pipelines, or slots, depending on the instruction type.

If there are arithmetic logic instructions in the instruction fetch bundle 52, a determination is made as to whether a value of a first slot instruction counter is less than a value of the second slot instruction counter 56. The first slot instruction counter maintains a value of the number of instructions currently assigned to a first slot. The second slot instruction counter maintains a value of the number of instructions currently assigned to a second slot. Those skilled in the art will understand that, in one or more other embodiments, a different number of counters may be used.

If the value of the first slot instruction counter is less than the value of the second slot instruction counter, the arithmetic logic instructions in the instruction fetch bundle are assigned to the first slot and the remaining non-arithmetic logic instructions in the instruction fetch bundle are assigned to the appropriate slots depending on the type of instruction 58. If the value of the first slot instruction is not less than the value of the second slot instruction counter, the arithmetic logic instructions in the instruction fetch bundle are assigned to the second slot and the remaining non-arithmetic logic instructions in the instruction fetch bundle are assigned to the appropriate slots depending on the type of instruction 60. Those skilled in the art will understand that, in one or more other embodiments of the present invention, if the value of the first slot instruction counter is not less than the value of the second slot instruction counter but is equal to the value of the second slot instruction counter, the arithmetic logic instructions in the instruction fetch bundle may instead be assigned to the first slot while the remaining non-arithmetic logic instructions in the instruction fetch bundle are assigned to the appropriate slots depending on the type of instruction.

After the instructions in the instruction fetch bundle are assigned to the appropriate slots, the first slot instruction counter is incremented by the number of instructions in the instruction fetch bundle assigned to the first slot and the second slot instruction counter is incremented by the number of instructions in the instruction fetch bundle assigned to the second slot 62. Those skilled in the art will appreciate that, in one or more other embodiments, the first and second slot instruction counters may be incremented as the instructions in the instruction fetch bundle are assigned to the first and second slots.

If an instruction assigned to the first slot get issued 64, the first slot instruction counter is decremented 66. Similarly, if an instruction assigned to the second slot gets issued 68, the second slot instruction counter is decremented 70. Those skilled in the art will understand that steps 64 and 66 and 68 and 70 may occur in any order and repeatedly as instructions are issued. For example, if two instructions are issued to the second slot before an instruction is issued to the first slot, the second slot instruction counter is decremented by two.

Furthermore, those skilled in the art will understand that, in one or more other embodiments of the present invention, the exemplary flow process shown in FIG. 3 may be applicable to an instruction type different than that of an arithmetic logic instruction. For example, if in a particular instruction set, the assignment and issuance of load/store instructions is of critical importance, the assignment and issuing process described with reference to FIG. 3 may be used to efficiently handle such load/store instructions.

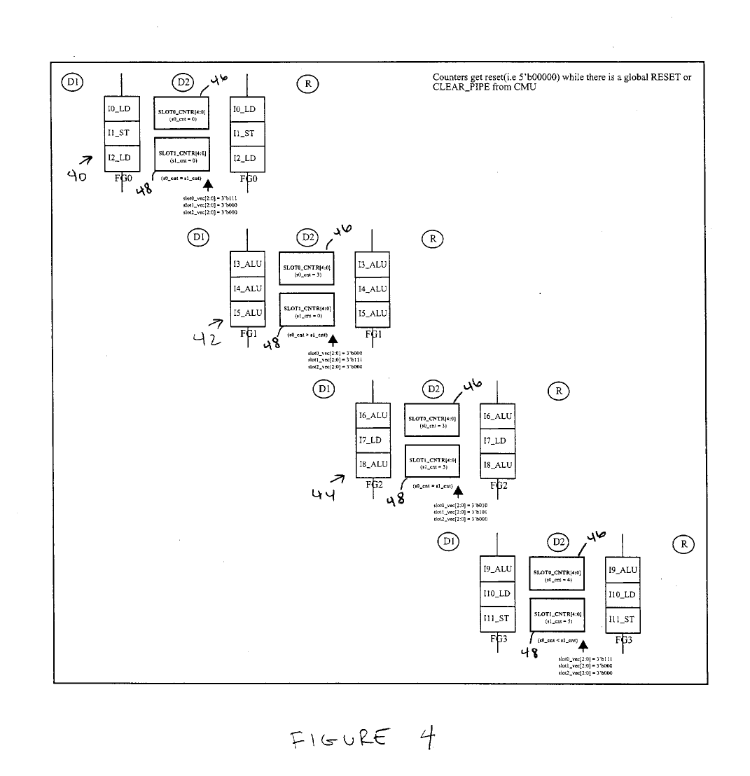

FIG. 4 shows an exemplary pipeline diagram in accordance with an embodiment of the present invention. In FIG. 4, a first instruction fetch bundle 40 contains a load instruction, a store instruction, and another load instruction. Because the instructions in this first instruction fetch bundle 40 are all load/store instructions, they are assigned to SLOT 0 (in the execution unit 38 shown in FIG. 2), which, in turn, causes SLOT0_CNTR (also shown as residing in the instruction decode unit 36 shown in FIG. 2) 46 to get incremented to 3 at the end of this cycle.

The second instruction fetch bundle 42 shown in FIG. 4 contains three arithmetic logic instructions. Because the value of SLOT0_CNTR (also shown as residing in the instruction decode unit 36 shown in FIG. 2) 46, 3, is greater than the value of SLOT1_CNTR (also shown as residing in the instruction decode unit 36 shown in FIG. 2) 48, 0, all three of these arithmetic logic instructions get assigned to SLOT 1 (in the execution unit 38 shown in FIG. 2), which, in turn, causes SLOT1_CNTR (also shown as residing in the instruction decode unit 36 shown in FIG. 2) 48 to get incremented to 3 at the end of this cycle.

The third instruction fetch bundle 44 shown in FIG. 4 contains an arithmetic logic instruction, a load instruction, and another arithmetic logic instruction. Because SLOT0_CNTR (also shown as residing in the instruction decode unit 36 shown in FIG. 2) 46 and SLOT1_CNTR (also shown as residing in the instruction decode unit 32 shown in FIG. 2) 48 both now have a value of 3, the two arithmetic logic instructions in the third instruction fetch bundle 44 are assigned to SLOT 1 (in the execution unit 38 shown in FIG. 2), which, in turn causes SLOT1_CNTR (also shown as residing in the instruction decode unit 36 shown in FIG. 2) 48 to get incremented to 5, and the single load instruction in the third instruction fetch bundle 44 is steered to SLOT 0 (in the execution unit 38 shown in FIG. 2), which, in turn, causes SLOT0_CNTR (also shown as residing in the instruction decode unit 36 shown in FIG. 2) 46 to get incremented to 4.

Advantages of the present invention may include one or more of the following. In one or more embodiments, because instructions are issued more efficiently, increased instruction level parallelism may be obtained, thereby improving issue bandwidth in a multi-issue processor.

In one or more embodiments, because an instruction assignment technique handles an often-occurring type of instruction in a manner so as to improve instruction issue efficiency of the often-occurring type of instruction, system performance may be improved.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for handling a plurality of instructions in a multi-issue processor, comprising:
determining whether there is a particular type of instruction in the plurality of instructions; and
if there is the particular type of instruction:
determining a first number of instructions assigned to a first pipeline,
determining a second number of instructions assigned to a second pipeline,
comparing the first number and the second number, and
assigning instructions of the particular type in the plurality of instructions to one of the first pipeline and the second pipeline depending on the comparing.

2. The method of claim 1, wherein the particular type of instruction is an arithmetic logic instruction.

3. The method of claim 1, the comparing comprising determining whether the first number is one of greater than, less than, and equal to the second number.

4. The method of claim 3, further comprising:
if the first number is greater than the second number, assigning the instructions of the particular type in the plurality of instructions to the second pipeline;
incrementing the second number by an amount of instructions in the plurality of instructions assigned to the second pipeline; and
incrementing the first number by an amount of instructions in the plurality of instructions assigned to the first pipeline.

5. The method of claim 4, further comprising:
issuing at least one of the instructions of the particular type assigned to the second pipeline to the second pipeline; and
decrementing the second number depending on the issuing.

6. The method of claim 5, wherein the issuing is dependent on whether the at least one of the instructions of the particular type assigned to the second pipeline is valid.

7. The method of claim 3, further comprising:
if the first number is less than the second number, assigning the instructions of the particular type in the plurality of instructions to the first pipeline;
incrementing the first number by an amount of instructions in the plurality of instructions assigned to the first pipeline; and
incrementing the second number by an amount of instructions in the plurality of instructions assigned to the second pipeline.

8. The method of claim 7, further comprising:
issuing at least one of the instructions of the particular type assigned to the first pipeline to the first pipeline; and
decrementing the first number depending on the issuing.

9. The method of claim 8, wherein the issuing is dependent on whether the at least one of the instructions of the particular type assigned to the first pipeline is valid.

10. The method of claim 3, further comprising:
if the first number is equal to the second number, assigning the instructions of the particular type in the plurality of instructions to the second pipeline;
incrementing the second number by an amount of instructions in the plurality of instructions assigned to the second pipeline; and
incrementing the first number by an amount of instructions in the plurality of instructions assigned to the first pipeline.

11. The method of claim 3, further comprising:
if the first number is equal to the second number, assigning the instructions of the particular type in the plurality of instructions to the first pipeline;
incrementing the first number by an amount of instructions in the plurality of instructions assigned to the first pipeline; and
incrementing the second number by an amount of instructions in the plurality of instructions assigned to the second pipeline.

12. The method of claim 1, further comprising:
decoding the plurality of instructions; and
if there are no instructions of the particular type in the plurality of instructions, assigning an instruction in the plurality of instructions to one of the first pipeline, the second pipeline, and a third pipeline dependent on the decoding.

13. A method for handling a plurality of instructions in a multi-pipelined processor, comprising:
step for determining whether there is a particular type of instruction in the plurality of instructions; and
if there is the particular type of instruction:
step for determining a first number of instructions assigned to a first pipeline,
step for determining a second number of instructions assigned to a second pipeline,
step for comparing the first number and the second number, and
step for assigning instructions of the particular type in the plurality of instructions to one of the first pipeline and the second pipeline depending on the step for comparing.

14. The method of claim 13, wherein the particular type of instruction is an arithmetic logic instruction.

15. The method of claim 13, further comprising:
if the first number is greater than the second number, step for assigning the instructions of the particular type in the plurality of instructions to the second pipeline;
step for incrementing the second number by an amount of instructions in the plurality of instructions assigned to the second pipeline; and
step for incrementing the first number by an amount of instructions in the plurality of instructions assigned to the first pipeline.

16. The method of claim 13, further comprising:
if the first number is less than the second number, step for assigning the instructions of the particular type in the plurality of instructions to the first pipeline;
step for incrementing the first number by an amount of instructions in the plurality of instructions assigned to the first pipeline; and
step for incrementing the second number by an amount of instructions in the plurality of instructions assigned to the second pipeline.

17. A microprocessor having at least a first pipeline and a second pipeline, comprising:
an instruction fetch unit arranged to fetch a plurality of instructions; and
an instruction decode unit arranged to assign identification information to the plurality of instructions, wherein the instruction decode unit is arranged to maintain a first count and a second count, and wherein the instruction decode unit is arranged to assign instructions of a particular type in the plurality of instructions to one of the first pipeline and the second pipeline dependent on the first count and the second count.

18. The microprocessor of claim 17, wherein the particular type of instruction is an arithmetic logic instruction.

19. The microprocessor of claim 17, wherein the first count is incremented by a number of instructions in the plurality of instructions assigned to the first pipeline, and wherein the second count is incremented by a number of instructions in the plurality of instructions assigned to the second pipeline.

20. The microprocessor of claim 17, wherein the instruction decode unit is further arranged to:
when the first count is greater than the second count, assign instructions of the particular type in the plurality of instructions to the second pipeline; and
when the first count is less than the second count, assign instructions of the particular type in the plurality of instructions to the first pipeline.

21. A method for handling a plurality of instructions in a processor having at least a first pipeline and a second pipeline, comprising:
determining if there is an arithmetic logic instruction in the plurality of instructions; and
if there is an arithmetic logic instruction in the plurality of instructions:
querying a first counter indicative of an amount of instructions assigned to the first pipeline,
querying a second counter indicative of an amount of instructions assigned to the second pipeline,
if a value of the first counter is greater than a value of the second counter, assigning arithmetic logic instructions in the plurality of instructions to the second pipeline, and
if the value of the first counter is less than the value of the second counter, assigning arithmetic logic instructions in the plurality of instructions to the first pipeline.
